(19) United States
(12) Patent Application Publication
(10) Pub. No.: US 2019/0259087 A1
(43) Pub. Date: Aug. 22, 2019

(54) Sales system combining online and offline

(71) Applicant: Shaohua Ren, Beijing (CN)

(72) Inventor: Shaohua Ren, Beijing (CN)

(21) Appl. No.: 16/501,097

(22) Filed: Feb. 23, 2019

Related U.S. Application Data
(63) Continuation of application No. PCT/CN2017/096997, filed on Aug. 11, 2017.

(30) Foreign Application Priority Data
Sep. 3, 2016 (CN) 2016108013954
Sep. 5, 2016 (CN) 2016108025082

(51) Int. Cl. G06Q 30/06; G06K 19/06; H04M 1/725; H04W 4/029; H04N 5/232

(52) U.S. Cl. CPC G06Q 30/0635; G06K 19/06028; G06K 19/06037; H04M 1/72572; H04M 2250/04; H04N 5/23206; H04M 1/72525; H04M 1/7253; G06K 2019/06253; H04W 4/029

(57) ABSTRACT

This invention provides a sales system combining online and offline which enables a user to contact the commodity offline and to purchase the commodity online, which makes the online and offline to be mutual beneficial.

### TECHNICAL FIELD

This invention relates to a sales system combining online and offline.

### BACKGROUND

Nowadays online sales have been very popular, but the defect that a commodity entity cannot be seen by a buyer still exists in the online sales compared with the offline sales.

Although at present the buyers can find the corresponding commodities on the internet through scanning the barcode of some products. However by the present mode the online is not combined with the offline, in which online and offline are independent from each other. So by the present mode the cost of showing the commodity is borne by the offline and the sales benefit is only obtained by the online sales platform. Meanwhile in the present mode the online platform cannot distinguish the commodity barcode used by the customer to know which offline outlet or offline platform the customer is at and see the commodity entity that makes the user buy the commodity at the online platform, so the online platform cannot evaluate the performance of the offline outlet or the offline platform. So the present mode is non-sustainable and unacceptable mode to the offline.

Besides there is no method to locate the online shop which is showing the commodity directly by the 2D barcode or the barcode of the commodity.

Besides there are similar problems as above in services sales-after the customers consults the sales personnel at the offline shop, if the customers buy the service from the online shop the sales personnel cannot record the performance.

### SUMMARY

In view of the above problems, this invention provides a sales system or method combining online and offline.

A sales system or method combining online and offline, includes an online platform and different commodities, and includes more than one offline outlet or offline platform; wherein the commodity is the object having an appearance and a touchable entity, and the offline outlet or offline platform shows the commodity and the identification information of the commodity outlet code to the users at the offline business site, and the identification information of the commodity outlet code is on or beside or attached to the commodity; wherein the user is capable of making the mobile phone get the commodity outlet code through the identification information of the commodity outlet code of a showed commodity, and then the mobile phone is capable of sending the commodity outlet code of the commodity to the online platform through the network, and then the online platform is capable of getting the commodity number of the commodity according to the commodity outlet code, and then the online platform is capable of sending the interface for purchasing the commodity to the user's mobile phone according to the commodity outlet code received from the user's mobile phone, and then the user is capable of purchasing the commodity on the interface for purchasing the commodity sent from the online platform on the mobile phone, and then the seller of the online platform is capable of transporting or delivering or mailing the commodity purchased by the user to the offline address designated by the user; wherein the online platform is capable of getting the outlet number of the offline outlet or offline platform according to the commodity outlet code, or the user's mobile phone is capable of positioning the offline outlet or offline platform by the mobile phone positioning through the wireless network or wireless signal or satellite positioning, and then the user's mobile phone is capable of sending the position or the outlet number of the outlet at which the user is located got by the mobile phone positioning to the online platform, and then the online platform is capable of getting the outlet number of the offline outlet or offline platform directly or through the position information.

Preferably, the identification information of the commodity outlet code is a graph, a graph code, a two-dimensional barcode or a barcode which is on or beside or attached to the showed commodity, wherein the user is capable of using the mobile phone's camera to scan the identification information of the commodity outlet code of a showed commodity to make the mobile phone get the commodity outlet code of the commodity.

Preferably, if the user enters the online platform interface for purchasing the commodity by the commodity outlet code to purchase the commodity, then after the purchase is completed the online platform is capable of getting the commodity outlet code or getting the outlet number which is corresponding to the commodity outlet code according to the record of the purchase.

Optionally, there is only one online platform and this online platform is selling all commodities showed offline.

Optionally, there is more than one online platform and the user's mobile phone is capable of sending the commodity outlet code to one or more than one or the user's chosen one of these online platforms.

Preferably, the identification information of the commodity outlet code is the information from which the commodity outlet code is capable of being got, and the mode of the identification information of the commodity outlet code may be a graphical mode or a character mode or a wireless mode or an infrared mode or an audio mode.

Optionally, the identification information of the commodity outlet code is the character string including the commodity outlet code.

Optionally, the identification information of the commodity outlet code is the wireless signal from which the commodity outlet code is capable of being got, or the identification information of the commodity outlet code is the information from which the commodity outlet code is capable of being got and which is the wireless signal or NFC signal of RFID signal or infrared signal or audio signal emitted by the device on or beside or attached to the showed commodity.

Preferably, the commodity outlet code is set by the online platform or the commodity outlet code is formed by combining the commodity number and the outlet number.

Preferably, the special program running on the user's mobile phone and provided by the online platform is capable of sending the commodity outlet code to the online platform through the network, and the user is capable of using the special program provided by the online platform to login the user's account at the online platform.

Optionally, from the commodity outlet code the user's mobile phone is capable of getting the name of or the address of or the link for or the mobile phone program for the online platform corresponding to the commodity outlet code, and the user's mobile phone is capable of sending the commodity outlet code to the corresponding online platform through the name of or the address of or the link for or the mobile phone program for the online platform corresponding to the commodity outlet code.

Optionally, the online platform is capable of evaluating the benefit or efficiency of the offline platform according to the order quantity of the showed commodities to the online platform and according to the offline platform's information corresponding to the commodity outlet codes of the showed commodities.

A sales system or method combining online and offline, includes an online platform and different commodities, and includes more than one offline outlet or offline platform; wherein the commodity is the object having an appearance and a touchable entity, and the offline outlet or offline platform shows the commodity and the identification information of the commodity outlet code to the users at the offline business site, and the identification information of the commodity outlet code is a graph, a graph code, a two-dimensional barcode or a barcode which is on or beside or attached to the showed commodity; wherein the user is capable of using the mobile phone's camera to scan the identification information of the commodity outlet code of a showed commodity to make the mobile phone get the commodity outlet code of the commodity, and then from the commodity outlet code the user's mobile phone is capable of getting the name of or the address of or the link for or the mobile phone program for the online platform corresponding to the commodity outlet code, and then the user's mobile phone is capable of sending the commodity outlet code to the corresponding online platform through the name of or the address of or the link for or the mobile phone program for the online platform corresponding to the commodity outlet code, or the user is capable of using the special program running on the mobile phone and provided by the online platform to open the mobile phone's camera to scan the identification information of the commodity outlet code of a showed commodity to make the special program get the commodity outlet code, and then the special program on the user's mobile phone is capable of sending the commodity outlet code to the online platform through the network; wherein the online platform is capable of getting the commodity number of the commodity according to the commodity outlet code, and then the online platform is capable of sending the interface for purchasing the commodity to the user's mobile phone or the special program running on the user's mobile phone according to the commodity outlet code received from the user's mobile phone, and then the user is capable of purchasing the commodity on the interface for purchasing the commodity sent from the online platform on the mobile phone or on the special program running on the user's mobile phone, and then the seller of the online platform is capable of transporting or delivering or mailing the commodity purchased by the user to the offline address designated by the user; wherein the online platform is capable of getting the outlet number of the offline outlet or offline platform according to the commodity outlet code, or the user's mobile phone is capable of positioning the offline outlet or offline platform by the mobile phone positioning through the wireless network or wireless signal or satellite positioning, and then the user's mobile phone is capable of sending the position or the outlet number of the outlet at which the user is located got by the mobile phone positioning to the online platform, and then the online platform is capable of getting the outlet number of the offline outlet or offline platform directly or through the position information.

Preferably, if the user enters the online platform interface for purchasing the commodity by the commodity outlet code to purchase the commodity, then after the purchase is completed the online platform is capable of getting the commodity outlet code or getting the outlet number which is corresponding to the commodity outlet code according to the record of the purchase.

Optionally, there is only one online platform and this online platform is selling all commodities showed offline.

Optionally, there is more than one online platform and the user's mobile phone is capable of sending the commodity outlet code to one or more than one or the user's chosen one of these online platforms.

Preferably, the commodity outlet code is set by the online platform or the commodity outlet code is formed by combining the commodity number and the outlet number.

Preferably, the user is capable of using the special program provided by the online platform to login the user's account at the online platform.

Optionally, from the commodity outlet code the user's mobile phone is capable of getting the name of or the address of or the link for or the mobile phone program for the online platform corresponding to the commodity outlet code, and the user's mobile phone is capable of sending the commodity outlet code to the corresponding online platform through the name of or the address of or the link for or the mobile phone program for the online platform corresponding to the commodity outlet code.

Optionally, the online platform is capable of evaluating the benefit or efficiency of the offline platform according to the order quantity of the showed commodities to the online platform and according to the offline platform's information corresponding to the commodity outlet codes of the showed commodities.

### BRIEF DESCRIPTION OF THE DRAWINGS

FIG. 1 is a network structure diagram of Embodiment 1.

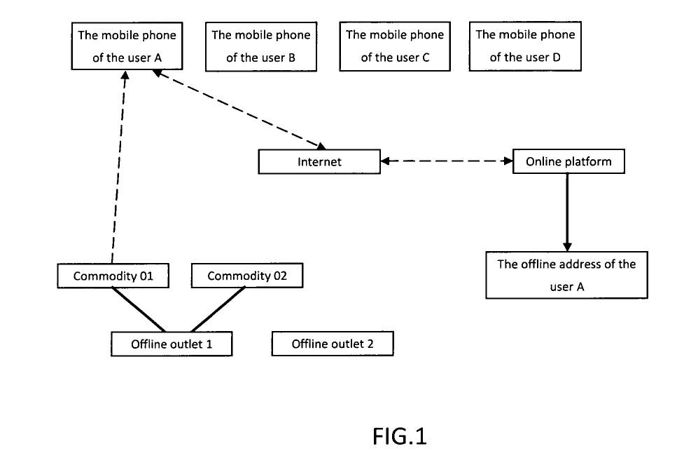

### DETAILED DESCRIPTION

### Embodiment 1

There is only one online platform in this embodiment. This online platform is an e-business website or online shopping mall which is selling entity commodities online. In this embodiment the online platform is an ICP on internet, and of course the online platform may also be changed to be cooperated by more than one ICP. This online platform establishes by itself and recruits the offline show store. The offline show store may be the offline outlet or the offline platform.

There is more than one offline outlet or more than one offline platform. And an offline platform may be a group of sales personnel or a franchised sales company having more than one offline outlet.

The commodity is the object with the entity having the physical appearance and physical sizes and being capable of being touched by the users, and to show commodity is to show the entity or the sample or the model of the commodity at the offline business site.

The offline outlet or offline platform shows the commodity and the identification information of the commodity outlet code to the users at the offline business site. The identification information of the commodity outlet code is on or beside or attached to the commodity. The user is capable of make the mobile phone get the commodity outlet code through the identification information of the commodity outlet code of a showed commodity.

In this embodiment the online platform has the offline showing shops operated by itself which are showing the commodity which the online platform is selling and the corresponding commodity outlet codes.

The identification information of the commodity outlet code is the information from which the commodity outlet code is capable of being got. The mode of the identification information of the commodity outlet code may be a graphical mode or a character mode or a wireless mode or an infrared mode or an audio mode. This embodiment apply the graphical mode and NFC mode to illustrate.

The identification information of the commodity outlet code is a graph, a graph code, a two-dimensional barcode or a barcode which is on or beside or attached to the showed commodity. For example: it's a two-dimensional barcode on or beside the commodity and there should be the name of the commodity on the page of the two-dimensional barcode. The user is capable of using the mobile phone's camera to scan the identification information of the commodity outlet code of a showed commodity to make the mobile phone get the commodity outlet code of the commodity.

Or different from the paragraph above, the identification information of the commodity outlet code is the NFC signal emitted by the device on or beside or attached to the showed commodity. For example: to put a tablet emitting the NFC signal beside the showed commodity. The user is capable of using the mobile phone with NFC function to scan the identification of the commodity outlet code of a showed commodity to make the mobile phone get the commodity outlet code of the commodity.

The commodity outlet code is set by the online platform and capable of being printed or made by the online platform (for example: 2 dimensional barcode), or the offline outlet or offline platform combines the commodity number from the online platform and its own outlet number to form the commodity outlet code (for example: to connect the character string “the commodity number” and the character string “the outlet number” to form a character string to make a 2 dimensional barcode to print.)

The user uses the mobile phone of self to download the special program provided by the online platform. The user uses the special program running on the mobile phone to get the commodity outlet code from the identification information of the commodity (for example: use the special program to open the mobile phone's camera to scan the 2 dimensional barcode or use the mobile phone's NFC function to scan the NFC signal.) The special program running on the user's mobile phone is capable of sending the commodity outlet code to the online platform through the network. The online platform is capable of sending the interface for purchasing the commodity to the special program provided by the online platform and running on the user's mobile phone to display according to the commodity outlet code, and the user is capable of purchasing the commodity in the interface of the special program. The user is capable of using the special program provided by the online platform to login the user's account at the online platform.

Or different from the paragraph above, the user's mobile phone is capable of getting the name or the address or the link or the mobile phone program according to the identification information of the commodity outlet code. The user's mobile phone is capable of sending the commodity outlet code to the corresponding online platform through the name or the address or the link or the mobile phone program corresponding to the commodity outlet code. For example: the user uses the scanning 2 dimensional barcode function of the internet browser in the mobile phone to scan the 2 dimensional barcode which is the identification information of the commodity outlet code, and the user's mobile phone gets the commodity outlet code, and the commodity outlet code includes the network address for the online platform or the name of the special program for the online platform, and then the internet browser on the user's mobile phone sends the commodity outlet code to the network address of the online platform or the internet browser on the user's mobile phone sends the commodity outlet code to the special program for the online platform running on the mobile phone to let the special program to transfer the commodity outlet code to the online platform, and the online platform is capable of sending the interface for purchasing the commodity to the internet browser or the special program running on the user's mobile phone according to the commodity outlet code. The user is capable of viewing and confirm the information of the commodity in the interface for purchasing the commodity, and viewing the photo or graph or the entity of the commodity, and viewing the text introduction or detailed parameters or the commodity. The user is capable of purchasing the commodity in the mobile phone's interface from the online platform for purchasing the commodity.

The online platform is capable of getting the commodity number of the commodity and the outlet number of the offline outlet or offline platform according to the commodity outlet code. The outlet number is set by the online platform. The commodity number is set by the online platform.

The seller of the online platform is capable of transporting or delivering or mailing the commodity purchased by the user to the offline address designated by the user. The seller of the online platform is the organization which is selling the commodities on the online platform. The seller of the online platform may be the internal department of the online platform or the external cooperating partner or the related party of the online platform. The commodities which the online platform is selling are operated by self of the online platform or other parties on the online platform.

If the user enters the online platform interface for purchasing the commodity by the commodity outlet code to purchase the commodity, then after the purchase is completed the online platform is capable of getting the commodity outlet code or getting the outlet number which is corresponding to the commodity outlet code according to the record of the purchase.

The online platform is capable of evaluating the benefit or efficiency of the offline platform according to the order quantity of the showed commodities to the online platform and according to the offline platform's information corresponding to the commodity outlet codes of the showed commodities.

A user is capable of using the mobile phone or the terminal to send the commodity outlet code to other user's mobile phone or terminal. A user is capable of using the mobile phone or the terminal to purchase a commodity on the online platform by the commodity outlet code of the commodity sent from other user to the user.

### Embodiment 2

There is more than one online platform in this embodiment. These online platforms are the e-business websites or the online shopping malls which are selling the entity commodities online. These online platforms establish by self the offline showing shops and recruit the offline showing shops. The offline showing shops may be the offline outlets or the offline platforms.

The user is capable of using the mobile phone to purchase the same commodity from the different online platforms through the commodity outlet code of the same commodity which is showed in the same offline outlet or offline platform. The different online platform are capable of using the same commodity outlet code of the same commodity, and the names of or the addresses of or the links for or the special programs for these online platforms are capable of being got from the commodity outlet code, and the user's mobile phone is capable of sending the commodity outlet code to one or more than one or the user's chosen one of these online platforms through the names of or the addresses of or the links for or the special programs for these online platforms.

The user's mobile phone is capable of getting the name of or the address of or the link for or the mobile phone program for the online platform or platforms corresponding to the commodity outlet code, and the user's mobile phone is capable of sending the commodity outlet code to the corresponding online platform or the online platform chosen by the user through the name of or the address of or the link for or the mobile phone program for the online platform corresponding to the commodity outlet code.

There is more than one offline outlet or more than one offline platform. And an offline platform may be a group of sales personnel or a franchised sales company having more than one offline outlet.

The commodity is the object with the entity having the physical appearance and physical sizes and being capable of being touched by the users, and to show commodity is to show the entity or the sample or the model of the commodity at the offline business site.

The offline outlet or offline platform shows the commodity and the identification information of the commodity outlet code to the users at the offline business site. The identification information of the commodity outlet code is on or beside or attached to the commodity. The user is capable of make the mobile phone get the commodity outlet code through the identification information of the commodity outlet code of a showed commodity.

In this embodiment the online platform has the offline showing shops operated by itself which are showing the commodity which the online platform is selling and the corresponding commodity outlet codes.

The identification information of the commodity outlet code is the information from which the commodity outlet code is capable of being got. The mode of the identification information of the commodity outlet code may be a graphical mode or a character mode or a wireless mode or an infrared mode or an audio mode. This embodiment apply the graphical mode and NFC mode to illustrate.

The identification information of the commodity outlet code is a graph, a graph code, a two-dimensional barcode or a barcode which is on or beside or attached to the showed commodity. For example: it's a two-dimensional barcode on or beside the commodity and there should be the name of the commodity on the page of the two-dimensional barcode. The user is capable of using the mobile phone's camera to scan the identification information of the commodity outlet code of a showed commodity to make the mobile phone get the commodity outlet code of the commodity.

Or different from the paragraph above, the identification information of the commodity outlet code is the NFC signal emitted by the device on or beside or attached to the showed commodity. For example: to put a tablet emitting the NFC signal beside the showed commodity. The user is capable of using the mobile phone with NFC function to scan the identification of the commodity outlet code of a showed commodity to make the mobile phone get the commodity outlet code of the commodity.

The commodity outlet code is set by the online platform and capable of being printed or made by the online platform (for example: 2 dimensional barcode), or the offline outlet or offline platform combines the commodity number from the online platform and its own outlet number to form the commodity outlet code (for example: to connect the character string “the commodity number” and the character string “the outlet number” to form a character string to make a 2 dimensional barcode to print.)

The user uses the mobile phone of self to download the special program provided by the online platform. The user uses the special program running on the mobile phone to get the commodity outlet code from the identification information of the commodity (for example: use the special program to open the mobile phone's camera to scan the 2 dimensional barcode or use the mobile phone's NFC function to scan the NFC signal.) The special program running on the user's mobile phone is capable of sending the commodity outlet code to the online platform through the network. The online platform is capable of sending the interface for purchasing the commodity to the special program provided by the online platform and running on the user's mobile phone to display according to the commodity outlet code, and the user is capable of purchasing the commodity in the interface of the special program. The user is capable of using the special program provided by the online platform to login the user's account at the online platform.

Or different from the paragraph above, the user's mobile phone is capable of getting the name or the address or the link or the mobile phone program according to the identification information of the commodity outlet code. The user's mobile phone is capable of sending the commodity outlet code to the corresponding online platform through the name or the address or the link or the mobile phone program corresponding to the commodity outlet code. For example: the user uses the scanning 2 dimensional barcode function of the internet browser in the mobile phone to scan the 2 dimensional barcode which is the identification information of the commodity outlet code, and the user's mobile phone gets the commodity outlet code, and the commodity outlet code includes the network address for the online platform or the name of the special program for the online platform, and then the internet browser on the user's mobile phone sends the commodity outlet code to the network address of the online platform or the internet browser on the user's mobile phone sends the commodity outlet code to the special program for the online platform running on the mobile phone to let the special program to transfer the commodity outlet code to the online platform, and the online platform is capable of sending the interface for purchasing the commodity to the internet browser or the special program running on the user's mobile phone according to the commodity outlet code. The user is capable of viewing and confirm the information of the commodity in the interface for purchasing the commodity, and viewing the photo or graph or the entity of the commodity, and viewing the text introduction or detailed parameters or the commodity. The user is capable of purchasing the commodity in the mobile phone's interface from the online platform for purchasing the commodity.

The online platform is capable of getting the commodity number of the commodity and the outlet number of the offline outlet or offline platform according to the commodity outlet code. The outlet number is set by the online platform. The commodity number is set by the online platform.

The seller of the online platform is capable of transporting or delivering or mailing the commodity purchased by the user to the offline address designated by the user. The seller of the online platform is the organization which is selling the commodities on the online platform. The seller of the online platform may be the internal department of the online platform or the external cooperating partner or the related party of the online platform. The commodities which the online platform is selling are operated by self of the online platform or other parties on the online platform.

If the user enters the online platform interface for purchasing the commodity by the commodity outlet code to purchase the commodity, then after the purchase is completed the online platform is capable of getting the commodity outlet code or getting the outlet number which is corresponding to the commodity outlet code according to the record of the purchase.

The online platform is capable of evaluating the benefit or efficiency of the offline platform according to the order quantity of the showed commodities to the online platform and according to the offline platform's information corresponding to the commodity outlet codes of the showed commodities.

A user is capable of using the mobile phone or the terminal to send the commodity outlet code to other user's mobile phone or terminal. A user is capable of using the mobile phone or the terminal to purchase a commodity on the online platform by the commodity outlet code of the commodity sent from other user to the user.

### Embodiment 3

In this embodiment, the user's mobile phone is capable of using the wireless network or the wireless signal or the satellite positioning to position the offline outlet or offline platform where the user is at, and the user's mobile phone is capable of sending the location or the outlet number of the offline outlet or offline platform where the user is to the online platform to make the online platform to get the outlet number the offline outlet or offline platform directly or through the location information. If the user enters the interface for purchasing a commodity from the online platform to purchase the commodity and the online platform gets the outlet number of the offline outlet or offline platform where the user is at, the online platform is capable of getting the outlet number of the offline outlet or offline platform according to the record of the purchase after the purchase is complete.

The online platform cannot get the outlet number of the offline outlet or offline platform which is showing the commodity outlet code only according to the commodity outlet code received. The commodity outlet code corresponds to only one commodity or commodity number but not to the offline outlet or offline platform or outlet number.

In this embodiment, there is only one online platform, and this online platform is an e-business website or online shopping mall which is selling entity commodities online. This online platform establishes by itself and recruits the offline show stores. The offline showing shops may be the offline outlets or the offline platforms. There is more than one offline outlet or more than one offline platform. And an offline platform may be a group of sales personnel or a franchised sales company having more than one offline outlet. The commodity is the object with the entity having the physical appearance and physical sizes and being capable of being touched by the users, and to show commodity is to show the entity or the sample or the model of the commodity at the offline business site. The offline outlet or offline platform shows the commodity and the identification information of the commodity outlet code to the users at the offline business site. The identification information of the commodity outlet code is on or beside or attached to the commodity. The user is capable of make the mobile phone get the commodity outlet code through the identification information of the commodity outlet code of a showed commodity.

In this embodiment the online platform has the offline showing shops operated by itself which are showing the commodity which the online platform is selling and the corresponding commodity outlet codes. The identification information of the commodity outlet code is the information from which the commodity outlet code is capable of being got. The mode of the identification information of the commodity outlet code may be a graphical mode or a character mode or a wireless mode or an infrared mode or an audio mode. This embodiment applies the graphical mode and NFC mode to illustrate.

The identification information of the commodity outlet code is a graph, a graph code, a two-dimensional barcode or a barcode which is on or beside or attached to the showed commodity. For example: it's a two-dimensional barcode on or beside the commodity and there should be the name of the commodity on the page of the two-dimensional barcode. The user is capable of using the mobile phone's camera to scan the identification information of the commodity outlet code of a showed commodity to make the mobile phone get the commodity outlet code of the commodity.

Or different from the paragraph above, the identification information of the commodity outlet code is the NFC signal emitted by the device on or beside or attached to the showed commodity. For example: to put a tablet emitting the NFC signal beside the showed commodity. The user is capable of using the mobile phone with NFC function to scan the identification of the commodity outlet code of a showed commodity to make the mobile phone get the commodity outlet code of the commodity.

The commodity outlet code is set by the online platform and capable of being printed or made by the online platform (for example: 2 dimensional barcode), or the commodity out code is formed by the offline outlet or offline platform according to the commodity numbers from the online platform.

The user uses the mobile phone of self to download the special program provided by the online platform. The user uses the special program running on the mobile phone to get the commodity outlet code from the identification information of the commodity (for example: use the special program to open the mobile phone's camera to scan the 2 dimensional barcode or use the mobile phone's NFC function to scan the NFC signal.) The special program running on the user's mobile phone is capable of sending the commodity outlet code to the online platform through the network. The online platform is capable of sending the interface for purchasing the commodity to the special program provided by the online platform and running on the user's mobile phone to display according to the commodity outlet code, and the user is capable of purchasing the commodity in the interface of the special program. The user is capable of using the special program provided by the online platform to login the user's account at the online platform.

Or different from the paragraph above, the user's mobile phone is capable of getting the name or the address or the link or the mobile phone program according to the identification information of the commodity outlet code. The user's mobile phone is capable of sending the commodity outlet code to the corresponding online platform through the name or the address or the link or the mobile phone program corresponding to the commodity outlet code. For example: the user uses the scanning 2 dimensional barcode function of the internet browser in the mobile phone to scan the 2 dimensional barcode which is the identification information of the commodity outlet code, and the user's mobile phone gets the commodity outlet code, and the commodity outlet code includes the network address for the online platform or the name of the special program for the online platform, and then the internet browser on the user's mobile phone sends the commodity outlet code to the network address of the online platform or the internet browser on the user's mobile phone sends the commodity outlet code to the special program for the online platform running on the mobile phone to let the special program to transfer the commodity outlet code to the online platform, and the online platform is capable of sending the interface for purchasing the commodity to the internet browser or the special program running on the user's mobile phone according to the commodity outlet code. The user is capable of viewing and confirm the information of the commodity in the interface for purchasing the commodity, and viewing the photo or graph or the entity of the commodity, and viewing the text introduction or detailed parameters or the commodity. The user is capable of purchasing the commodity in the mobile phone's interface from the online platform for purchasing the commodity.

The online platform is capable of getting the commodity number of the commodity.

The outlet number is set by the online platform. The commodity number is set by the online platform.

The seller of the online platform is capable of transporting or delivering or mailing the commodity purchased by the user to the offline address designated by the user. The seller of the online platform is the organization which is selling the commodities on the online platform. The seller of the online platform may be the internal department of the online platform or the external cooperating partner or the related party of the online platform. The commodities which the online platform is selling are operated by self of the online platform or other parties on the online platform.

The online platform is capable of evaluating the benefit or efficiency of the offline platform according to the order quantity of the showed commodities to the online platform and according to the offline platform's information corresponding to the commodity outlet codes of the showed commodities.

A user is capable of using the mobile phone or the terminal to send the commodity outlet code to other user's mobile phone or terminal. A user is capable of using the mobile phone or the terminal to purchase a commodity on the online platform by the commodity outlet code of the commodity sent from other user to the user.

### Embodiment 4

In this embodiment, the user's mobile phone is capable of using the wireless network or the wireless signal or the satellite positioning to position the offline outlet or offline platform where the user is at, and the user's mobile phone is capable of sending the location or the outlet number of the offline outlet or offline platform where the user is to the online platform to make the online platform to get the outlet number the offline outlet or offline platform directly or through the location information. If the user enters the interface for purchasing a commodity from the online platform to purchase the commodity and the online platform gets the outlet number of the offline outlet or offline platform where the user is at, the online platform is capable of getting the outlet number of the offline outlet or offline platform according to the record of the purchase after the purchase is complete.

The online platform cannot get the outlet number of the offline outlet or offline platform which is showing the commodity outlet code only according to the commodity outlet code received. The commodity outlet code corresponds to only one commodity or commodity number but not to the offline outlet or offline platform or outlet number.

In this embodiment, there is more than one online platform, and these online platforms are the e-business websites or online shopping malls which are selling entity commodities online. These online platforms establish by themselves and recruit the offline show stores. The offline showing shops may be the offline outlets or the offline platforms.

The user is capable of using the mobile phone to purchase the same commodity from the different online platforms through the commodity outlet code of the same commodity which is showed in the same offline outlet or offline platform. The different online platform are capable of using the same commodity outlet code of the same commodity, and the names of or the addresses of or the links for or the special programs for these online platforms are capable of being got from the commodity outlet code, and the user's mobile phone is capable of sending the commodity outlet code to one or more than one or the user's chosen one of these online platforms through the names of or the addresses of or the links for or the special programs for these online platforms.

The user's mobile phone is capable of getting the name of or the address of or the link for or the mobile phone program for the online platform or platforms corresponding to the commodity outlet code, and the user's mobile phone is capable of sending the commodity outlet code to the corresponding online platform or the online platform chosen by the user through the name of or the address of or the link for or the mobile phone program for the online platform corresponding to the commodity outlet code.

There is more than one offline outlet or more than one offline platform. And an offline platform may be a group of sales personnel or a franchised sales company having more than one offline outlet. The commodity is the object with the entity having the physical appearance and physical sizes and being capable of being touched by the users, and to show commodity is to show the entity or the sample or the model of the commodity at the offline business site. The offline outlet or offline platform shows the commodity and the identification information of the commodity outlet code to the users at the offline business site. The identification information of the commodity outlet code is on or beside or attached to the commodity. The user is capable of make the mobile phone get the commodity outlet code through the identification information of the commodity outlet code of a showed commodity.

In this embodiment the online platform has the offline showing shops operated by itself which are showing the commodity which the online platform is selling and the corresponding commodity outlet codes. The identification information of the commodity outlet code is the information from which the commodity outlet code is capable of being got. The mode of the identification information of the commodity outlet code may be a graphical mode or a character mode or a wireless mode or an infrared mode or an audio mode. This embodiment applies the graphical mode and NFC mode to illustrate.

The identification information of the commodity outlet code is a graph, a graph code, a two-dimensional barcode or a barcode which is on or beside or attached to the showed commodity. For example: it's a two-dimensional barcode on or beside the commodity and there should be the name of the commodity on the page of the two-dimensional barcode. The user is capable of using the mobile phone's camera to scan the identification information of the commodity outlet code of a showed commodity to make the mobile phone get the commodity outlet code of the commodity.

Or different from the paragraph above, the identification information of the commodity outlet code is the NFC signal emitted by the device on or beside or attached to the showed commodity. For example: to put a tablet emitting the NFC signal beside the showed commodity. The user is capable of using the mobile phone with NFC function to scan the identification of the commodity outlet code of a showed commodity to make the mobile phone get the commodity outlet code of the commodity.

The commodity outlet code is set by the online platform and capable of being printed or made by the online platform (for example: 2 dimensional barcode), or the commodity out code is formed by the offline outlet or offline platform according to the commodity numbers from the online platform (for example: the offline platform makes 2 dimensional barcode to print).

The user uses the mobile phone of self to download the special program provided by the online platform. The user uses the special program running on the mobile phone to get the commodity outlet code from the identification information of the commodity (for example: use the special program to open the mobile phone's camera to scan the 2 dimensional barcode or use the mobile phone's NFC function to scan the NFC signal.) The special program running on the user's mobile phone is capable of sending the commodity outlet code to the online platform through the network. The online platform is capable of sending the interface for purchasing the commodity to the special program provided by the online platform and running on the user's mobile phone to display according to the commodity outlet code, and the user is capable of purchasing the commodity in the interface of the special program. The user is capable of using the special program provided by the online platform to login the user's account at the online platform.

Or different from the paragraph above, the user's mobile phone is capable of getting the name or the address or the link or the mobile phone program according to the identification information of the commodity outlet code. The user's mobile phone is capable of sending the commodity outlet code to the corresponding online platform through the name or the address or the link or the mobile phone program corresponding to the commodity outlet code. For example: the user uses the scanning 2 dimensional barcode function of the internet browser in the mobile phone to scan the 2 dimensional barcode which is the identification information of the commodity outlet code, and the user's mobile phone gets the commodity outlet code, and the commodity outlet code includes the network address for the online platform or the name of the special program for the online platform, and then the internet browser on the user's mobile phone sends the commodity outlet code to the network address of the online platform or the internet browser on the user's mobile phone sends the commodity outlet code to the special program for the online platform running on the mobile phone to let the special program to transfer the commodity outlet code to the online platform, and the online platform is capable of sending the interface for purchasing the commodity to the internet browser or the special program running on the user's mobile phone according to the commodity outlet code. The user is capable of viewing and confirm the information of the commodity in the interface for purchasing the commodity, and viewing the photo or graph or the entity of the commodity, and viewing the text introduction or detailed parameters or the commodity. The user is capable of purchasing the commodity in the mobile phone's interface from the online platform for purchasing the commodity.

The online platform is capable of getting the commodity number of the commodity.

The outlet number is set by the online platform. The commodity number is set by the online platform.

The seller of the online platform is capable of transporting or delivering or mailing the commodity purchased by the user to the offline address designated by the user. The seller of the online platform is the organization which is selling the commodities on the online platform. The seller of the online platform may be the internal department of the online platform or the external cooperating partner or the related party of the online platform. The commodities which the online platform is selling are operated by self of the online platform or other parties on the online platform.

If the user enters the online platform interface for purchasing the commodity by the commodity outlet code to purchase the commodity, then after the purchase is completed the online platform is capable of getting the commodity outlet code or getting the outlet number which is corresponding to the commodity outlet code according to the record of the purchase.

The online platform is capable of evaluating the benefit or efficiency of the offline platform according to the order quantity of the showed commodities to the online platform and according to the offline platform's information corresponding to the commodity outlet codes of the showed commodities.

A user is capable of using the mobile phone or the terminal to send the commodity outlet code to other user's mobile phone or terminal. A user is capable of using the mobile phone or the terminal to purchase a commodity on the online platform by the commodity outlet code of the commodity sent from other user to the user.

<Additional Description for the 4 Embodiments Above>

The 4 embodiments above may also have any suitable and applicable characteristics or steps described in the following paragraphs. Meanwhile, some characteristics or steps described in the following paragraphs are not suitable and applicable to some of the 4 embodiments above.

The mobile phone is capable of connecting to mobile communication network.

The mobile phone is the portable computer device with the operating system.

The mobile phone is capable of connecting the internet through the mobile computer network.

The mobile phone or the mobile terminal has a display screen.

The mobile phone has a touchable display screen.

There is one online platform or there is more than one online platform.

There is only one online platform. There is only one online platform and this online platform is selling all commodities showed offline.

There is more than one online platform. The user is capable of purchasing the same commodity from the different online platforms by the commodity outlet code of the same showed commodity in the same offline outlet or offline platform. The different online platforms are capable of using the same commodity outlet code of the same commodity. The user's mobile phone is capable of getting the names of or the addresses of or the links for or the mobile phone special programs for the online platforms. The user's mobile phone is capable of sending the commodity outlet code to the one or more than one platform or the user's chosen one of these online platforms.

The online platform is an e-business website or an online shopping mall.

The online platform is an ICP (internet content provider) on the internet. The ICP receiving the commodity outlet code and the ICP sending the interface for purchasing the commodity are the same ICP on the internet as the online platform.

The online platform is cooperated by more than one ICP on the internet. There is an ICP receiving the commodity outlet code as the online platform, and there is another cooperating ICP sending the interface for purchasing the commodity as the online platform.

The online platform uses the same network address or the same server group. The online platform receives the commodity outlet code and sends the interface for purchasing the commodity by the same network address or the same server group.

The online platform uses different network addresses and different server groups. The online platform receives the commodity outlet code and sends the interface for purchasing the commodity by the different netword addresses or the different server groups.

The online platform is an organization or a company.

The online platform is cooperated by more than one organization or company.

There is more than one offline outlet or offline platform. The more than one offline outlet or offline platform refers to more than one offline outlet, or more than one offline platform, or at least one offline outlet and at least one offline platform. The offline platform includes at least one offline outlet.

The business site of the offline outlet or offline platform is capable of counting number of customers in a period of time.

The offline outlet is an offline business site.

An offline platform includes one or more than one outlet. If an offline platform includes more than one outlet, the outlet number of this offline platform corresponds to all the outlets included by this offline platform.

An offline platform includes one or more than one sales person. If an offline platform includes more than one sales person, the outlet number of this offline platform corresponds to all the sales persons included by this offline platform.

An offline platform may be a sales organization. For example: an offline platform is an offline line sales company, and the company may include the special outlet and the sales persons at the non-special outlets, and the outlet number of this offline platform corresponds to this whole sales company.

There are different commodities. There is more than one kind of commodity.

The commodity is the object having an appearance and a touchable entity. The commodity is the object with the entity having the physical appearance and physical sizes and being capable of being touched by the users.

The commodity is the object having an appearance and a touchable entity. To show commodity is to show the entity or the sample or the model of the commodity at the offline business site, and the showed commodity refers to the entity or the sample or the model of the showed commodity.

The offline outlet or offline platform shows the commodity and the identification information of the commodity outlet code to the users at the offline business site, and the identification information of the commodity outlet code is a graph, a graph code, a two-dimensional barcode or a barcode which is on or beside or attached to the showed commodity, and the user is capable of using the mobile phone camera to scan the identification information of the commodity outlet code of a showed commodity to make the mobile phone to get the commodity outlet code of the commodity.

The information of the commodity out code is on or beside or attached to the showed commodity.

The user is capable of making the mobile phone get the commodity outlet code of a commodity through the identification information of the commodity outlet code of the showed commodity.

The identification information of the commodity outlet code is the information from which the commodity outlet code is capable of being got. The mode of the identification information of the commodity outlet code may be a graphical mode or a character mode or a wireless mode or an infrared mode or an audio mode.

The information is a graph or character string or a wireless signal or an audio signal or an infrared signal or other information.

The identification information of the commodity outlet code is a graph, a graph code, a two-dimensional barcode or a barcode from which the commodity outlet code is capable of being got. The user is capable of using the mobile phone's camera to scan the graph or the graph code or the two-dimensional barcode or the barcode which is as the identification information of the commodity outlet code of a showed commodity to make the mobile phone get the commodity outlet code of the commodity. The special program running on the user's mobile phone and provided by the online platform is capable of getting the commodity outlet code from the graph or the graph code or the two-dimensional barcode or the barcode which is the identification information of the commodity outlet code.

The identification information of the commodity outlet code is the character string including the commodity outlet code. The methods by which user's mobile phone gets the commodity outlet code from the character string as the identification of the commodity outlet code include: the user inputs the character string into the special program running on the mobile phone and provided by the online platform, or the user uses the special program running on the mobile phone and provided by the online platform to open the mobile phone's camera to scan the character string, or the user uses voice to input the character string into the special program running on the mobile phone and provided by the online platform (the special program running on the mobile phone is capable of recognizing the character string by voice).

The identification information of the commodity outlet code is the wireless signal from which the commodity outlet code is capable of being got. The identification information of the commodity outlet code is the wireless signal from which the commodity outlet code is capable of being got, which is: infrared or WIFI or Blue tooth or RFID or NFC.

The information of the commodity out code is the wireless signal or NFC signal of RFID signal or infrared signal or audio signal emitted by the device on or beside or attached to the showed commodity.

The identification information of the commodity outlet code is the NFC signal from which the commodity outlet code is capable of being got. The user uses the mobile phone to get the commodity outlet code from the NFC signal which is the identification information of the commodity outlet code through the wireless mode. The special program running on the user's mobile phone and provided by the online platform is capable of getting the commodity outlet code from the NFC signal which is the identification information of the commodity outlet code. The NFC is near field communication.

The identification information of the commodity outlet code is the RFID signal from which the commodity outlet code is capable of being got. The user uses the mobile phone to get the commodity outlet code from the RFID signal which is the identification information of the commodity outlet code through the wireless mode. The special program running on the user's mobile phone and provided by the online platform is capable of getting the commodity outlet code from the RFID signal which is the identification information of the commodity outlet code. The RFID is a non-contact type radio frequency identification.

The identification information of the commodity outlet code is the infrared signal from which the commodity outlet code is capable of being got. The user uses the mobile phone to get the commodity outlet code from the infrared signal which is the identification information of the commodity outlet code through the wireless mode. The special program running on the user's mobile phone and provided by the online platform is capable of getting the commodity outlet code from the infrared signal which is the identification information of the commodity outlet code.

The identification information of the commodity outlet code is the voice signal from which the commodity outlet code is capable of being got. The user uses the mobile phone to get the commodity outlet code from the voice signal which is the identification information of the commodity outlet code through the wireless mode. The special program running on the user's mobile phone and provided by the online platform is capable of getting the commodity outlet code from the voice signal which is the identification information of the commodity outlet code.

The commodity outlet code is set by the online platform or the commodity outlet code is formed by combining the commodity number and the outlet number. The commodity outlet code of the commodity may be set by the online platform and provided by the online platform to the related commodity or the offline outlet or the offline platform. Or the offline outlet or offline platform is capable of combining the commodity number and the outlet number to form the commodity outlet code of the commodity.

The user's mobile phone is capable of downloading and installing a special program which is provided by the online platform.

The special program running on the user's mobile phone and provided by the online platform is capable of sending the commodity outlet code to the online platform through the network. The special program running on the user's mobile phone and provided by the online platform is capable of getting the commodity outlet code from the identification information of the commodity outlet code. The online platform is capable of sending the interface for purchasing the commodity to the special program running on the user's mobile phone and provided by the online platform to display according to the commodity outlet code received. The user is capable of using the special program running on the mobile phone and provided by the online platform to purchase the commodity by the commodity outlet code on the online platform.

The user is capable of using the special program provided by the online platform to login the user's account at the online platform.

The user is capable of using the mobile phone to register the user's account at the online platform. The user has the user account at the online platform. The user's account at the online platform has the information of the user's delivery address.

From the commodity outlet code the user's mobile phone is capable of getting the name of or the address of or the link for or the mobile phone program for the online platform corresponding to the commodity outlet code. The user's mobile phone is capable of sending the commodity outlet code to the corresponding online platform through the name of or the address of or the link for or the mobile phone program for the online platform corresponding to the commodity outlet code.

The user's mobile phone is capable of getting the name of or the address of or the link for or the mobile phone program for the online platform or platforms corresponding to the commodity outlet code. The name is a domain name or a website name or an application name or a company name. The address is a HTTP address or an IP address or a WWW address or other address. The link is a HTTP link or other network link. The mobile phone program is the program installed and running on the mobile phone. The mobile phone program is the special program provided by the online platform.

The user's mobile phone is capable of sending the commodity outlet code to the corresponding online platform or the online platform chosen by the user through the name of or the address of or the link for or the mobile phone program for the online platform corresponding to the commodity outlet code.

The user's mobile phone is capable of sending the commodity outlet code to the online platform through the network.

The online platform is capable of getting the commodity number of the commodity and the outlet number of the offline outlet or offline platform according to the commodity outlet code.

A commodity outlet code corresponds to only one offline outlet or one offline platform or one outlet number. A commodity outlet code corresponds to only one offline outlet or offline platform. A commodity outlet code corresponds to only one outlet number.

An offline outlet or offline platform corresponds to more than one commodity outlet code. Or an offline outlet or offline platform corresponds to one or more than one commodity outlet code.

The online platform stores the outlet number corresponding to one offline outlet or offline platform and more than one commodity number corresponding to this offline outlet or offline platform.

A commodity outlet code corresponds to only one commodity number or one commodity. A commodity outlet code corresponds to only one commodity number. A commodity outlet code corresponds to only one commodity.

A commodity corresponds to more than one commodity outlet number. Or a commodity corresponds to one or more than one commodity outlet code.

The online platform stores a commodity number corresponding to a commodity and more than one commodity outlet code corresponding to the commodity.

An commodity outlet code corresponds to one commodity or one commodity number and corresponds to one offline outlet or offline platform.

The outlet number is set by the online platform.

An outlet number corresponds to only one offline platform or offline outlet.

An offline outlet or offline platform corresponds to at least one outlet number.

The online platform stores the outlet number of each offline outlet or offline platform.

The commodity number is set by the online platform.

A commodity number corresponds to only one commodity.

A commodity corresponds to at least one commodity number.

The online platform stores the commodity number of each commodity which the online platform is selling.

The code or the number is a character string. The commodity outlet code is a character string. The commodity number is a character string. The outlet number is a character string.

The online platform is capable of sending the interface for purchasing a commodity to the user's mobile phone according to the commodity's commodity outlet code received from the user's mobile phone.

The user is capable of viewing and confirming the information of a commodity in the interface for purchasing the commodity. The user is capable of viewing the photo or the graph of the entity of the commodity in the interface for purchasing the commodity. The user is capable of viewing the text introduction information or the specific parameters of the commodity in the interface for purchasing the commodity.

The user is capable of purchasing a commodity in the user's mobile phone's interface for purchasing the commodity sent from the online platform.

The user is capable of purchasing a commodity on the mobile phone from the online platform through the commodity outlet code of the commodity.

The steps by which the user purchases a commodity from the online platform on the mobile phone include that the user pays through the internet.

The seller of the online platform is capable of transporting or delivering or mailing the commodity purchased by the user to the offline address designated by the user.

The seller of the online platform is the organization selling on the online platform. The seller of the online platform is the internal department of the online platform or the external cooperating partner of the online platform or the related party of the online platform.

The commodity which the online platform is selling is the commodity which the online platform runs by itself or the commodity which other parties are selling on the online platform.

If the user enters the online platform interface for purchasing the commodity by the commodity outlet code to purchase the commodity, then after the purchase is completed the online platform is capable of getting the commodity outlet code or getting the outlet number which is corresponding to the commodity outlet code according to the record of the purchase

The commodity is showed offline and sold online.

The online platform is capable of evaluating the benefit or efficiency of the offline platform according to the order quantity of the showed commodities to the online platform and according to the offline platform's information corresponding to the commodity outlet codes of the showed commodities.

A user is capable of using the mobile phone or the terminal to send the commodity outlet code to other user's mobile phone or terminal. A user is capable of using the mobile phone or the terminal to purchase a commodity on the online platform by the commodity outlet code of the commodity sent from other user to the user.

The user is capable of using the special program running on the mobile phone and provided by the online platform to open the mobile phone's camera to scan the identification information of the commodity outlet code of a showed commodity to make the special program get the commodity outlet code. The special program on the user's mobile phone is capable of sending the commodity outlet code to the online platform through the network. The online platform is capable of getting the commodity number of the commodity according to the commodity outlet code. And the online platform is capable of sending the interface for purchasing the commodity to the special program running on the mobile phone and provided by the online platform according to the commodity outlet code received from the user's mobile phone. The user is capable of using the user's mobile phone's special program provided by the online platform to purchasing the commodity in the interface for purchasing the commodity sent from the online platform.

The special program running on the user's mobile phone and provided by the online platform is capable of getting the name or the address or the link of one or more than one online platform corresponding to the commodity outlet code according to the commodity outlet code, and the special program running on the user's mobile phone is capable of sending the commodity outlet code to the online platform corresponding to the commodity outlet code or to the online platform chosen by the user through the name or the address or the link corresponding to the commodity outlet code.

The user is capable of using the special program running on the mobile phone to make the mobile phone get the commodity outlet code of a commodity through the identification information of the commodity outlet code of the commodity.

The user's mobile phone is capable of positioning the offline outlet or offline platform where the user is at by the mobile phone positioning through the wireless network or the wireless signal or the satellite.

The user's mobile phone is capable of sending the location of the offline outlet or offline platform where the user is at got by the mobile phone positioning to the online platform to make the online platform get the outlet number of the offline outlet or offline platform directly or through the location information.

If the user enters the interface for purchasing a commodity from the online platform to purchase the commodity and the online platform gets the outlet number of the offline outlet or offline platform where the user is at, the online platform is capable of getting the outlet number of the offline outlet or offline platform according to the record of the purchase after the purchase is complete.

When the user's mobile phone gets the commodity number from the identification information of the commodity outlet code the mobile phone is capable of positioning the offline outlet or offline platform through the wireless network or the wireless signal or the satellite positioning.

When the user uses the mobile phone to send the commodity number to the online platform the user's mobile phone is capable of positioning the offline outlet or offline platform through the wireless network or the wireless signal or the satellite positioning.

When the user's mobile phone uses the wireless network or the wireless signal or the satellite positioning to position the offline outlet or offline platform where the user is at the user's mobile phone will ask the user to confirm or to choose.

There is the name or the introduction or the photograph of a commodity beside the graph or the graph code or the 2 dimensional barcode or the barcode.

There is the name of a commodity beside the graph or the graph code or the 2 dimensional barcode or the barcode.

There is the introduction of a commodity beside the graph or the graph code or the 2 dimensional barcode or the barcode.

There is the photograph of a commodity beside the graph or the graph code or the 2 dimensional barcode or the barcode.

There are the name, the introduction and the photograph of a commodity beside the graph or the graph code or the 2 dimensional barcode or the barcode.

1. A sales system combining online and offline, includes an online platform and different commodities, and includes more than one offline outlet or offline platform; wherein the commodity is the object having an appearance and a touchable entity, and the offline outlet or offline platform shows the commodity and the identification information of the commodity outlet code to the users at the offline business site, and the identification information of the commodity outlet code is on or beside or attached to the commodity; wherein the user is capable of making the mobile phone get the commodity outlet code through the identification information of the commodity outlet code of a showed commodity, and then the mobile phone is capable of sending the commodity outlet code of the commodity to the online platform through the network, and then the online platform is capable of getting the commodity number of the commodity according to the commodity outlet code, and then the online platform is capable of sending the interface for purchasing the commodity to the user's mobile phone according to the commodity outlet code received from the user's mobile phone, and then the user is capable of purchasing the commodity on the interface for purchasing the commodity sent from the online platform on the mobile phone, and then the seller of the online platform is capable of transporting or delivering or mailing the commodity purchased by the user to the offline address designated by the user; wherein the online platform is capable of getting the outlet number of the offline outlet or offline platform according to the commodity outlet code, or the user's mobile phone is capable of positioning the offline outlet or offline platform by the mobile phone positioning through the wireless network or wireless signal or satellite positioning, and then the user's mobile phone is capable of sending the position or the outlet number of the outlet at which the user is located got by the mobile phone positioning to the online platform, and then the online platform is capable of getting the outlet number of the offline outlet or offline platform directly or through the position information.

2. The sales system combining online and offline according to claim 1, characterized in that the identification information of the commodity outlet code is a graph, a graph code, a two-dimensional barcode or a barcode which is on or beside or attached to the showed commodity, wherein the user is capable of using the mobile phone's camera to scan the identification information of the commodity outlet code of a showed commodity to make the mobile phone get the commodity outlet code of the commodity.

3. The sales system combining online and offline according to claim 1, characterized in that if the user enters the online platform interface for purchasing the commodity by the commodity outlet code to purchase the commodity, then after the purchase is completed the online platform is capable of getting the commodity outlet code or getting the outlet number which is corresponding to the commodity outlet code according to the record of the purchase.

4. The sales system combining online and offline according to claim 1, characterized in that there is only one online platform and this online platform is selling all commodities showed offline

5. The sales system combining online and offline according to claim 1, characterized in that there is more than one online platform and the user's mobile phone is capable of sending the commodity outlet code to one or more than one or the user's chosen one of these online platforms.

6. The sales system combining online and offline according to claim 1, characterized in that the identification information of the commodity outlet code is the information from which the commodity outlet code is capable of being got, and the mode of the identification information of the commodity outlet code may be a graphical mode or a character mode or a wireless mode or an infrared mode or an audio mode.

7. The sales system combining online and offline according to claim 1, characterized in that the identification information of the commodity outlet code is the character string including the commodity outlet code.

8. The sales system combining online and offline according to claim 1, characterized in that the identification information of the commodity outlet code is the wireless signal from which the commodity outlet code is capable of being got, or the identification information of the commodity outlet code is the information from which the commodity outlet code is capable of being got and which is the wireless signal or NFC signal of RFID signal or infrared signal or audio signal emitted by the device on or beside or attached to the showed commodity.

9. The sales system combining online and offline according to claim 1, characterized in that the commodity outlet code is set by the online platform or the commodity outlet code is formed by combining the commodity number and the outlet number.

10. The sales system combining online and offline according to claim 1, characterized in that the special program running on the user's mobile phone and provided by the online platform is capable of sending the commodity outlet code to the online platform through the network, and the user is capable of using the special program provided by the online platform to login the user's account at the online platform.

11. The sales system combining online and offline according to claim 1, characterized in that from the commodity outlet code the user's mobile phone is capable of getting the name of or the address of or the link for or the mobile phone program for the online platform corresponding to the commodity outlet code, and the user's mobile phone is capable of sending the commodity outlet code to the corresponding online platform through the name of or the address of or the link for or the mobile phone program for the online platform corresponding to the commodity outlet code.

12. The sales system combining online and offline according to claim 1, characterized in that the online platform is capable of evaluating the benefit or efficiency of the offline platform according to the order quantity of the showed commodities to the online platform and according to the offline platform's information corresponding to the commodity outlet codes of the showed commodities.

13. A sales system combining online and offline, includes an online platform and different commodities, and includes more than one offline outlet or offline platform; wherein the commodity is the object having an appearance and a touchable entity, and the offline outlet or offline platform shows the commodity and the identification information of the commodity outlet code to the users at the offline business site, and the identification information of the commodity outlet code is a graph, a graph code, a two-dimensional barcode or a barcode which is on or beside or attached to the showed commodity; wherein the user is capable of using the mobile phone's camera to scan the identification information of the commodity outlet code of a showed commodity to make the mobile phone get the commodity outlet code of the commodity, and then from the commodity outlet code the user's mobile phone is capable of getting the name of or the address of or the link for or the mobile phone program for the online platform corresponding to the commodity outlet code, and then the user's mobile phone is capable of sending the commodity outlet code to the corresponding online platform through the name of or the address of or the link for or the mobile phone program for the online platform corresponding to the commodity outlet code, or the user is capable of using the special program running on the mobile phone and provided by the online platform to open the mobile phone's camera to scan the identification information of the commodity outlet code of a showed commodity to make the special program get the commodity outlet code, and then the special program on the user's mobile phone is capable of sending the commodity outlet code to the online platform through the network; wherein the online platform is capable of getting the commodity number of the commodity according to the commodity outlet code, and then the online platform is capable of sending the interface for purchasing the commodity to the user's mobile phone or the special program running on the user's mobile phone according to the commodity outlet code received from the user's mobile phone, and then the user is capable of purchasing the commodity on the interface for purchasing the commodity sent from the online platform on the mobile phone or on the special program running on the user's mobile phone, and then the seller of the online platform is capable of transporting or delivering or mailing the commodity purchased by the user to the offline address designated by the user; wherein the online platform is capable of getting the outlet number of the offline outlet or offline platform according to the commodity outlet code, or the user's mobile phone is capable of positioning the offline outlet or offline platform by the mobile phone positioning through the wireless network or wireless signal or satellite positioning, and then the user's mobile phone is capable of sending the position or the outlet number of the outlet at which the user is located got by the mobile phone positioning to the online platform, and then the online platform is capable of getting the outlet number of the offline outlet or offline platform directly or through the position information.

14. The sales system combining online and offline according to claim 13, characterized in that if the user enters the online platform interface for purchasing the commodity by the commodity outlet code to purchase the commodity, then after the purchase is completed the online platform is capable of getting the commodity outlet code or getting the outlet number which is corresponding to the commodity outlet code according to the record of the purchase.

15. The sales system combining online and offline according to claim 13, characterized in that there is only one online platform and this online platform is selling all commodities showed offline.

16. The sales system combining online and offline according to claim 13, characterized in that there is more than one online platform and the user's mobile phone is capable of sending the commodity outlet code to one or more than one or the user's chosen one of these online platforms.

17. The sales system combining online and offline according to claim 13, characterized in that the commodity outlet code is set by the online platform or the commodity outlet code is formed by combining the commodity number and the outlet number.

18. The sales system combining online and offline according to claim 13, characterized in that the user is capable of using the special program provided by the online platform to login the user's account at the online platform.

19. The sales system combining online and offline according to claim 13, characterized in that from the commodity outlet code the user's mobile phone is capable of getting the name of or the address of or the link for or the mobile phone program for the online platform corresponding to the commodity outlet code, and the user's mobile phone is capable of sending the commodity outlet code to the corresponding online platform through the name of or the address of or the link for or the mobile phone program for the online platform corresponding to the commodity outlet code.

20. The sales system combining online and offline according to claim 13, characterized in that the online platform is capable of evaluating the benefit or efficiency of the offline platform according to the order quantity of the showed commodities to the online platform and according to the offline platform's information corresponding to the commodity outlet codes of the showed commodities.
